(19) United States
(12) Patent Application Publication
(10) Pub. No.: US 2021/0382466 A1
(43) Pub. Date: Dec. 9, 2021

(54) Automated Distributed and Staged Manufacturing

(71) Applicant: Karma Automotive LLC, Irvine, CA (US)

(72) Inventor: Liang Zhou, Irvine, CA (US)

(21) Appl. No.: 17/339,954

(22) Filed: Jun. 5, 2021

Related U.S. Application Data
(60) Provisional application No. 63/035,602, filed on Jun. 5, 2020.

(51) Int. Cl. G05B 19/418

(52) U.S. Cl. CPC G05B 19/41875; G05B 19/4183; G05B 19/41885; G05B 19/41865

(57) ABSTRACT

A system is provided to facilitate distributed manufacturing process in accordance with various embodiments. The system can include one or more supplier systems, a strong house system, a customer system, a product/quality control management system, a block chain system, and/or any other systems or devices.

### FIELD OF THE INVENTION

The invention generally relates to automated and staged manufacturing of a product.

### BACKGROUND OF THE INVENTION

Bringing a new product to market, from idea generation to delivering the finished product to customers, has historically been a long and arduous process. From the time a company or individual first conceives of a new product to the time a customer holds the finished product may take months or years, depending on the nature of the product. During this process, market success of this product is largely depending on prediction's targeted consumer needs and a bit of luck.

Taking automotive manufacturing as example, this process typically involves research and development (R&D), design, mass production, sales and marketing. In the design phases, various choices are typically taken into account for the target customer group. For example, if the target customer group includes young male below age of 30, the design choices will often balance between different sub-groups within that target customer group. However, it is often hard to have a one size that fits all design appealing to all of that customer group. Thus, design choices would spawn into different models for the cars with different features. Even with such differentiated designs for a customer group, the ultimate success of the automobile would still hinge on the different models' success at “speaking” to the customer group. This is often hard to predict. Various factors could affect customer's taste over relatively short time period.

### SUMMARY OF THE INVENTION

A key recognized by the inventor(s) is that to meet the requirements of a special market, there should be a quick plan to design the product meeting these requirements, manufacturing them and delivering the product to the customer(s) swiftly. In this process, a challenge lies in identifying cost effective components swiftly and, manufacturing and delivering the products in short amount of time. Another challenge is that typically a customer with specialized requirements for a product is not convinced that someone can meet these requirements and deliver the product quickly for the customer's business arrangement.

The inventor(s) envisions that to convince the customer, a manufacturer may need to enter into a non-binding contract with the customer. This may mean the customer does not make payment (or only makes a small partial payment) to facilitate the manufacturing. The key in this process is then how to carry out the operations in a fashion payments can be guaranteed once the products are delivered to the customer and found to meet the customer's requirements.

For facilitating fast operation in this process, one insight the inventor(s) came up with is to distribute the manufacturing across different entities. As mentioned above, the key is to ensure quick turn-around to meet the customer's evolving requirements. This may be achieved by dice the operations for the manufacturing into multiple pieces. For example, once the customer's requirements are provided, design can be broken into different pieces and completed by different entities. These different design entities can locate in different time zones so that they may work on the design cooperatively around the clock. For example, one design entity may be located in China and another design entity may be located in the US. These two entities may work together in the design process so that the Chinese design entity may work during the off hours of the US design entity and vice versa. This around clock cooperation can also be achieved in the component supplying for the products. Multiple component suppliers can be selected to manufacture various different components of the product around the clock to ensure quick production of the final product.

Other objects and advantages of the invention will be apparent to those skilled in the art based on the following drawings and detailed description.

### BRIEF DESCRIPTION OF THE DRAWINGS

FIG. 1 illustrates an example of a system configured to facilitate distributed manufacturing in accordance with the disclosure.

FIG. 2 illustrates one example of various communications among a customer system, a strong house system and a block chain system in accordance with the disclosure.

FIG. 3 shows one example of various communications among a strong house system, a supplier system, a product/quality control management system and a block chain system in accordance with the disclosure.

FIG. 4 illustrates an example for the strong house system shown in FIG. 1.

FIG. 5 illustrates an example for the product/quality control management system shown in FIG. 1.

FIG. 6 illustrates a simplified computer system that can be used implement various embodiments described and illustrated herein.

### DETAILED DESCRIPTION

Distributed manufacturing refers to a manufacturing approach in which, instead of having a company design and manufacture a product and then have the product shipped to a customer, products are designed, manufactured, finished, assembled, and/or shipped by one or more entities based on a variety of factors including, for example, product requirements, manufacturing capabilities and availability, location of parties, and the like. One insight provided by this present disclosure is that often there is a niche in the market that is not quite at the level of mass product production for that section of the market, and yet is much larger than customization on an individual level.

For example, there could exist a special market that have a set of product or equipment requirements for specific business goals. For instance, an online retailer may have a specific set of requirements for its delivery trucks such that cost, efficiency and reliability are achieved in an optimal balance. These delivery trucks may not necessarily require powerful engines to be able to speed through traffic, but may require fuel efficiency and low maintenance cost. This set of requirements may also evolve as online retailer's business changes. Over the time, there could be more or less requirements in the set. For instance, as the online retailer expands its reach to rural areas, the delivery trucks in its fleet may need bigger size such that they may hold more goods on a delivery trip.

The traditional centralized manufacturing is inflexible to meet such an evolving special market on a relative short notice. Manufacturers under the traditional centralized approach typically have a long and drawn out R&D process and by the time they finally figure out how to satisfy the special market's requirements, these requirements may already have evolved. Thus, inventor(s) of this disclosure have come up with a process in which a distributive manufacturing is used to meet the quick and evolving special market requirements.

A key recognized by the inventor(s) is that to meet the requirements of a special market, there should be a quick plan to design the product meeting these requirements, manufacturing them and delivering the product to the customer(s) swiftly. In this process, a challenge lies in identifying cost effective components swiftly and, manufacturing and delivering the products in short amount of time. Another challenge is that typically a customer with specialized requirements for a product is not convinced that someone can meet these requirements and deliver the product quickly for the customer's business arrangement.

Still take the automotive manufacturing as an example, the online retailer may have a set of requirements including the new delivery trucks that should have a certain size, meet a certain fuel efficiency threshold, not exceed certain maximum operating/maintenance cost over a fixed period of time, total cost for each truck should not exceed a cap amount and the like. Such requirements are often difficult to meet and new design is needed. Otherwise, this would not be a niche demand for it already fits into the existing manufacturing capacity. Therefore, the customer would be often skeptical as to whether a manufacturer can offer the product within the parameters of these requirements or even better.

The inventor(s) envisions that to convince the customer, a manufacturer may need to enter into a non-binding contract with the customer. This may mean the customer does not make payment (or only makes a small partial payment) to facilitate the manufacturing. The key in this process is then how to carry out the operations in a fashion payments can be guaranteed once the products are delivered to the customer and found to meet the customer's requirements.

For facilitating fast operation in this process, one insight the inventor(s) came up with is to distribute the manufacturing across different entities. As mentioned above, the key is to ensure quick turn around to meet the customer's evolving requirements. This may be achieved by dice the operations for the manufacturing into multiple pieces. For example, once the customer's requirements are provided, design can be broken into different pieces and completed by different entities. These different design entities can locate in different time zones so that they may work on the design cooperatively around the clock. For example, one design entity may be located in China and another design entity may be located in the US. These two entities may work together in the design process so that the Chinese design entity may work during the off hours of the US design entity and vice versa. This around clock cooperation can also be achieved in the component supplying for the products. Multiple component suppliers can be selected to manufacture various different components of the product around the clock to ensure quick production of the final product.

However, this distributed manufacturing process raises at least two questions. One is quality control and product management and another is payment facilitation. With distributed manufacturing, product management and quality control obviously become more difficult. That is how to achieve the customer's requirements with different entities working on them in different locations at different times. It should be understood this challenge is not only for ensuring the final product indeed meets the requirements, but also for ensuring the final product will be completed by the time required by the customer. As mentioned above, in some cases, the distributed manufacturing may be carried out by multiple entities on the understanding that payments to them for the part they participated in the process will be made after the products are delivered and found meet the customer's requirements. These entities would then need guarantees that this arrangement will indeed be realized after they have contributed to the delivered products. Addressing these two questions thus become important for such distributed manufacturing process.

For addressing the product and quality control issue, the inventor(s) has come up with the insight to put a production/quality system in place such that the different entities can be plugged in and out to participate in the process. Product management is an interdisciplinary role that reaches across teams to plan, design, and continuously bring better products to market. The role evolved out of a set of responsibilities that traditionally fell to different entities scoping out problems and making critical decisions. In this novel system, various functions are implemented to ensure each participating entity will meet sub-requirement(s) for their part in the process. In essence, for each product manufacturing process, this system will break the overall customer requirement into different sub-requirements for individual parts in the process. Still taking the automotive manufacturing as an example, the overall requirements for the truck may be broken into sub-requirements for the chassis, sub-requirements for the battery, sub-requirements for the upper body of the truck, and so on. These requirements can be stored in the system and individual entities can be managed through individual sub-requirements. For instance, there may different entities selected to work the design of chassis, and different entities selected to work on the battery for the truck. In that case, these entities can be plugged into system such that their work progress towards the sub-requirements can be verified at different check points to ensure they are meeting their sub-requirements. If one or more the selected entities do not meet their sub-requirements during and/or after the process, these entities may be plugged out of the system and new entities may be selected.

For addressing the questions regarding the non-binding aspect of this process, the inventor(s) has come up with the insight to employ block chain technology to facilitate this process. Transactions performed in the distributed manufacturing process mentioned herein, may be recorded to a ledger or block chain, which may be distributed and stored on multiple computers of different parties. These transactions may include transactions among the participants in this process. For example, there could be transactions between the product assemble entity and the customer, transactions between the assemble entity and one or more component suppliers, transactions between a component supplier with one or more sub-component suppliers, and transactions between the assemble entity and one or more design entities, and the like.

The particular block chain used to record the transactions in this process can also allow for a varied level of control on different activities product manufacturing cycle. For example, in some instances every operation may be recorded to the block chain, while in other examples, certain important transactions may be recorded to the block chain while other transactions are recorded “off-chain” in a traditional ledger or data store. In some examples, transactions may be batched off-chain and written to the block chain in a batch periodically (e.g., daily, weekly, monthly, etc.) or upon occurrence of an event (e.g., performance of a contract or delivery of a product).

In some cases, the block chain used in the process can be used in tandem with the product/quality control system mentioned above. For example, a transaction may be recorded with a particular status in accordance with the verification results provided by the product/quality control system. This level of control and verification can be applied to a broad range of participating entities in the process. With the block chain, smart-contract among different entities in the process can be achieved to enable payment at the time of delivery, upon performance of contract terms, or upon occurrence of certain milestones or events during the process. In some cases, the smart-contracts can include compliance-based payment mechanisms pre-written into the contract (i.e. the customer pays the full price of the item if they do not comply with the prescribed contract terms, or receives incentive payments based on short- or long-term performance of contract terms). This smart-contract capability can further be expanded by creating a compliance-based cost model for items, whereby the block chain-enabled transactions creates verifiable logs detailing which entities performed contract obligations at which time. By writing this data to an accessible block chain, providers will be able to track use of items and compliance with contract terms (e.g., warranty terms, license terms, etc.) that can be easily, automatically, digitally, and irrefutably verified.

### Example Distributed Manufacturing System

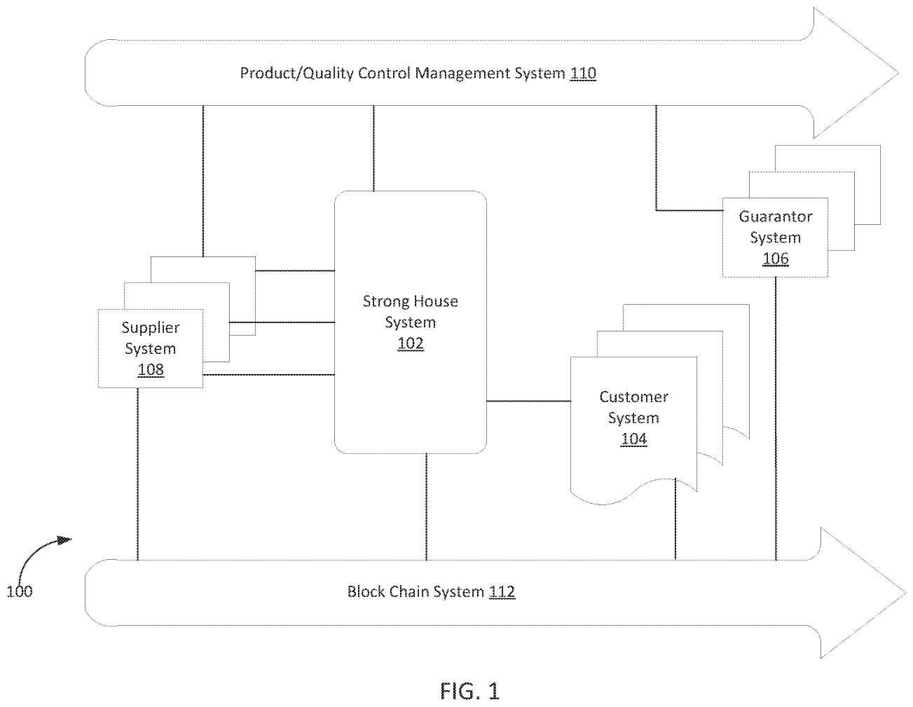

FIG. 1 is a schematic diagram illustrating an example system 100 usable to implement distributed manufacturing techniques such as those described herein. As shown in FIG. 1, the system 100 can include a strong house system 102, one or more customer systems 104, one or more guarantor systems 106, one or more supplier systems 108, a product/quality control management system 110, a block chain system 112, and/or any other systems or devices. The one or more customer systems 104 may associated with one or more customers. An individual customer system 104 may be configured to provide one or more requirements and/or specifications for a product desired by a customer associated with the customer. For example, the customer system 104 may be associated with an online retailer and may be configured to provide a set of requirements for a type of new delivery trucks suitable to its delivery in a rural area. The customer system 104 may be configured to communicate with the product/quality control management system 110 to ensure and monitor the progress of the manufacturing/delivering of the desired product. In some cases, the customer system 104 may be configured to generate a report to reflect such progress(es) for presentation to one or more decision makers, managers, staff and other entities within the customer. In some cases, the customer system 104 may be configured to instigate transaction completion tasks within system 100, which may include payments to various entities participated in the process. Other functions of the customer system 104 are contemplated.

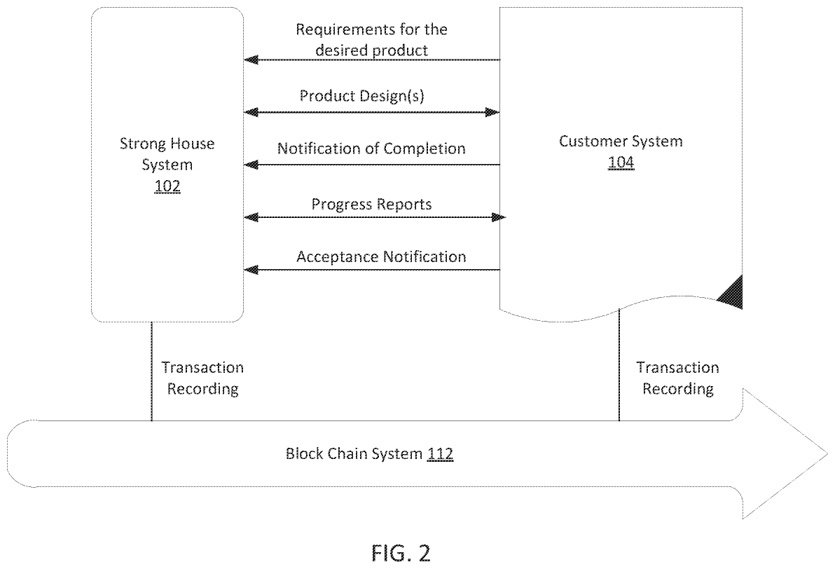

The strong house system 102 may be configured to perform various communications with a particular customer system 104. FIG. 2 illustrates an example of such communications. As shown in FIG. 2, the strong house system 102 can be configured to receive a set of requirements for the desired product provided by the customer system 104. After receiving the requirements, the strong house system 102 can be configured to send out one or more designs to the customer system 104 indicating one or more proposed the designs for the desired product. The customer system 104 may send one or more acceptance notifications indicating whether any or multiple ones of the proposed designs are accepted by the customer. The strong house system 102 can then be configured to send one or more notification of completion indicating whether the desired product has been completed and/or progress/milestones achieved towards the completion of the desired product. The customer system 104 can then send one or more acceptance notifications indicating whether the products as delivered by the strong house have meet the set of requirements provided to the strong house system 102.

As also shown in FIG. 2, the strong house system 102 and customer system 104 can be configured to communicate with the block chain system 112 to record transactions during the distributed manufacturing process. For example, once the proposed designs are accepted by the customer system 104, the customer system 104 can record a transaction indicating an order of the desired products from the strong house in the block chain. This transaction may include terms such as units to be delivered, reference to requirements for performance and delivery of the desired product for payments, timelines/milestones to be achieved to continue the process, price, and/or any other terms.

Similarly, the strong house system 102 can also be configured to record/modify transactions to the block chain system 112 during the process. For example, once a milestone is achieved as specified in the transaction initiated by the customer system 104 mentioned above, it may modify the transaction to reflect such a status has been achieved. As will be described below, the strong house system 102 can also be configured to create transactions in relation to the initial transaction created by the customer system 104.

Returning to FIG. 1, the system 100 can include one or more supplier systems 108. A given supplier system 108 can be associated with a supplier—for example, such as component supplier or a design house, which may or may not be located proximately to the entity associated with the strong house system 102. For instance, a given component supplier may be located in a different time zone as the entity associated with the strong house system 102.

As mentioned above, in the distributed manufacturing process in accordance with the disclosure, the strong house system 102 can be configured to analyze the requirements received from the customer system 104 for a target product and obtain a list of sub-requirements. A key for facilitating the distributed manufacturing process is to distribute the designing and/or manufacturing of the target product across multiple and different component suppliers and design house(s).

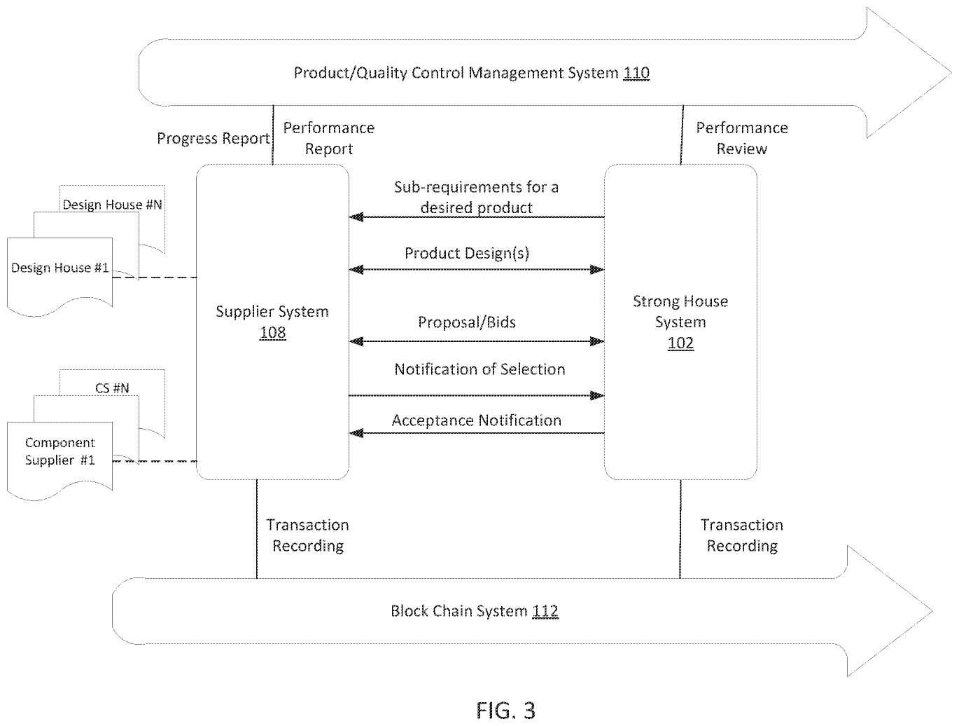

In some examples, a given supplier system 108 may be operatively connected to the strong house system 102 through a network, a cloud, and/or any other communications means. FIG. 3 shows one example of communications between a given supplier system 108 and the strong house system 102 in accordance with the disclosure. As shown, communications may include one or more sub-requirements for the desired product. For instance, the strong house system 102 may have analyzed the requirements received from the customer system 104 and map out multiple sub-components for the desired product. The strong house system 102 can send one or more requirements for a given sub-component to one or more supplier systems 108. As shown, the supplier systems may be associated with design houses and/or component suppliers.

As illustration, take the delivery truck for example, the strong house system 102 may obtain the requirements from the customer system 104 for the delivery truck desired by the customer associated with the customer system 104. Afterwards, the strong house system 102 may be configured to map out multiple sub-systems for the delivery truck—for example power train, battery, engine, chassis, upper body and etc. For each sub-system, the strong house system 102 can analyze the overall requirements and obtain sub-requirements for the particular system. For instance, one or more sub-requirements may be obtained for the power train, battery, engine, chassis, upper body and etc.

As shown, the sub-requirements for a particular component of the desired product may be communicated to the supplier system 108. Likewise, designs of the desired product may also be communicated to the given supplier system 108. After receiving the sub-requirements and/or product design(s), the given supplier system 108 can provide a bid/proposal in response. For example, the bid can indicate a price bid for supplying a component in compliance with the sub-requirements. As another example, the bid can indicate a time frame during which the components required for the desired product will be completed. Other terms of the bid that can be submitted by the supplier system 108 are contemplated. In some examples, the bid can include information indicating a design for the desired product.

As shown, after the bid is provided to the strong house system 102, the strong house system 102 can generate notification notifying the supplier system 108 that the bid is selected by the strong house system 102. As shown, in that case, the supplier system 108/strong house system 102 can be configured to record a transaction in the block chain system 112 after the bid is selected.

As mentioned above, in the distributed manufacturing process in accordance with the disclosure, it is important to ensure quality for each component/design selected for the desired product. As shown FIG. 3, once a bid is selected by the strong house system 102 and the actual work underlying the bid (e.g., component manufacturing or design drawing) is in progress, the supplier system 108 may provide various progress reports to the product/quality control management system 110. Product/quality control management system 110 can be configured with one or more quality assurance standards to ensure the selected suppliers are producing up to the one or more quality assurance standards. This may involve product quality control based on progress reports reported back by the supplier system 108. The product/quality control management system 110 may be configured to evaluate the progress reports and generate performance reports for feedbacks to the supplier system 108. For example, such performance reports may include scores and review comments for the progress of the component/design. As shown, in some examples, the strong house system 102 may provide the performance review to the product/quality control management system 110, which then can feed the review back to the supplier system 108.

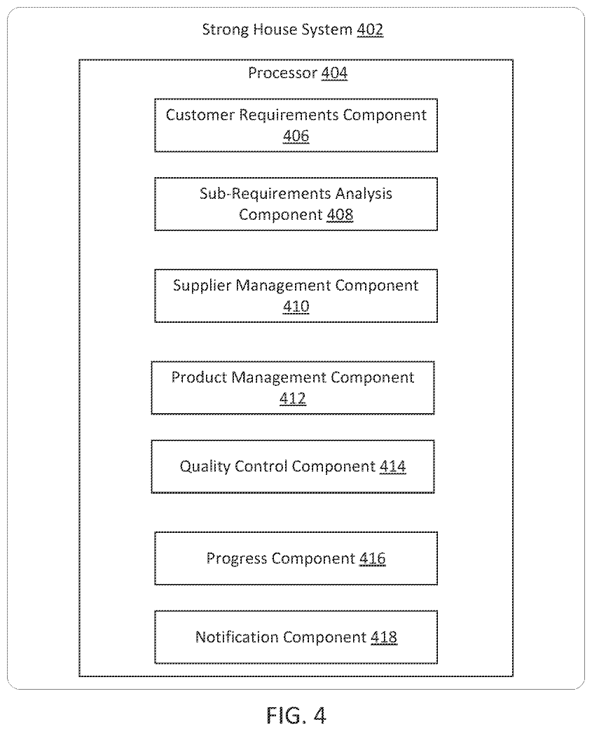

Having generally described the system 100 configured to facilitate the distributed manufacturing in general, attention is directed to FIG. 4, where an example of strong house system 402 is illustrated. As shown, the strong house system 402 can comprise a processor 404 configured to execute one or more computer components including a customer requirements component 406, a sub-requirements analysis component 408, a supplier management component 410, a product management component 412, a quality control component 414, a progress component 416, a notification component 418, and/or any other components.

The customer requirements component 406 can be configured to receive a set of requirements for the desired product provided by a customer system such as customer system 104 shown in FIG. 1.

The sub-requirements analysis component 408 can be configured to obtain a set of sub-requirements based on the requirements received by the customer requirements component 406.

The supplier management component 410 can be configured to manage one or more suppliers selected for the desired product as described herein.

The product management component 412 may be configured to manage a progress of the desired product as described herein.

The quality control component 414 may be configured to manage a quality of a component/design for the desired product as described herein.

The progress component 416 may be configured to monitor various progresses as described herein.

The notification component 418 can be configured to generate various notifications as described herein.

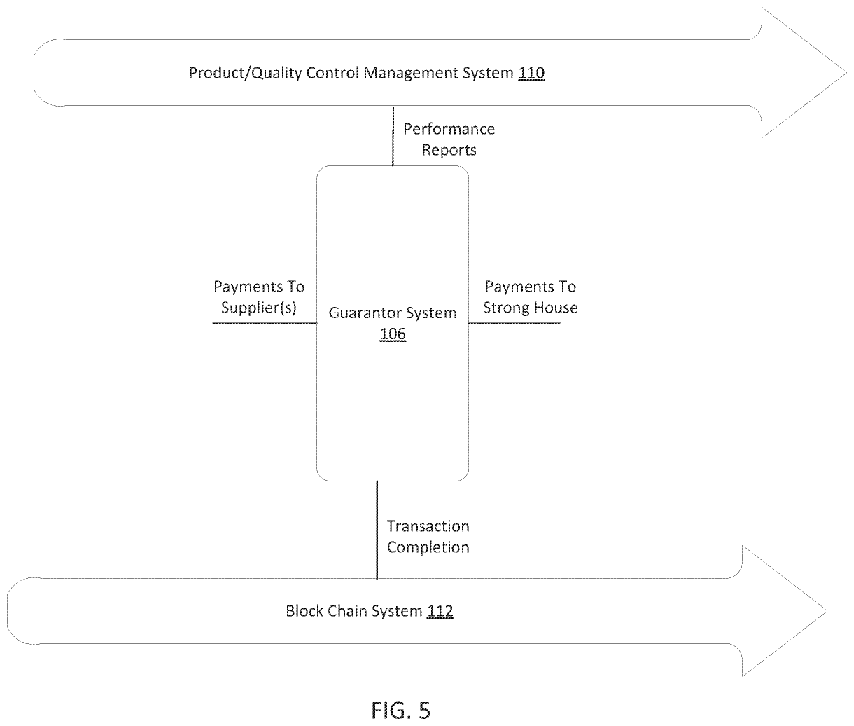

Attention is now directed to FIG. 5, where it illustrates an example communications to the guarantor system 106. As shown, the guarantor system 106 can be configured to communicate with the supplier system 108 and the strong house system 102 to make payments. The guarantor system 106 can also be configured to communicate with block chain system 112 to obtain a status of a transaction. For example, the guarantor system 106 will make payments to strong house system 102 after the desired product is delivered and tested be in compliance with the requirements. As shown, the guarantor system 106 can communicate product/quality control management system 110 to obtain performance reports for the manufacturing of the desired product.

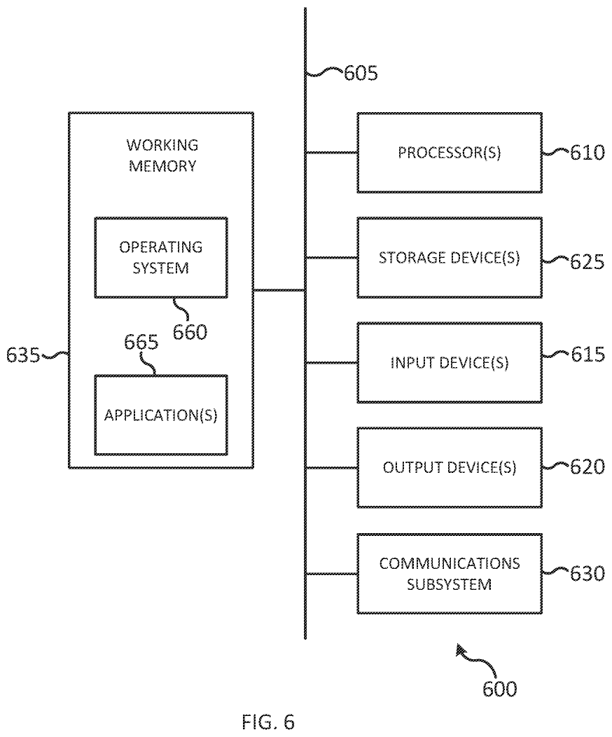

FIG. 6 illustrates a simplified computer system that can be used implement various embodiments described and illustrated herein. A computer system 600 as illustrated in FIG. 6 may be incorporated into devices such as a portable electronic device, mobile phone, or other device as described herein. FIG. 6 provides a schematic illustration of one embodiment of a computer system 600 that can perform some or all of the steps of the methods provided by various embodiments. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 606, or may otherwise be in communication, as appropriate. The hardware elements may include one or more processors 66, including without limitation one or more general-purpose processors and/or one or more special-purpose processors such as digital signal processing chips, graphics acceleration processors, and/or the like; one or more input devices 616, which can include without limitation a mouse, a keyboard, a camera, and/or the like; and one or more output devices 620, which can include without limitation a display device, a printer, and/or the like.

The computer system 600 may further include and/or be in communication with one or more non-transitory storage devices 626, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 600 might also include a communications subsystem 630, which can include without limitation a modem, a network card (wireless or wired), an infrared communication device, a wireless communication device, and/or a chipset such as a Bluetooth™ device, an 602.11 device, a WiFi device, a WiMax device, cellular communication facilities, etc., and/or the like. The communications subsystem 630 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 630. In other embodiments, a portable electronic device, e.g. the first electronic device, may be incorporated into the computer system 600, e.g., an electronic device as an input device 616. In some embodiments, the computer system 600 will further comprise a working memory 636, which can include a RAM or ROM device, as described above.

The computer system 600 also can include software elements, shown as being currently located within the working memory 636, including an operating system 660, device drivers, executable libraries, and/or other code, such as one or more application programs 666, which may comprise computer programs provided by various embodiments, and/or may be designed to implement methods, and/or configure systems, provided by other embodiments, as described herein. Merely by way of example, one or more procedures described with respect to the methods discussed above, such as those described in relation to FIG. 6, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 626 described above. In some cases, the storage medium might be incorporated within a computer system, such as computer system 600. In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by the computer system 600 and/or might take the form of source and/or installable code, which, upon compilation and/or installation on the computer system 600 e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 600 to perform methods in accordance with various embodiments of the technology. According to a set of embodiments, some or all of the procedures of such methods are performed by the computer system 600 in response to processor 66 executing one or more sequences of one or more instructions, which might be incorporated into the operating system 660 and/or other code, such as an application program 666, contained in the working memory 636. Such instructions may be read into the working memory 636 from another computer-readable medium, such as one or more of the storage device(s) 626. Merely by way of example, execution of the sequences of instructions contained in the working memory 636 might cause the processor(s) 66 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 600, various computer-readable media might be involved in providing instructions/code to processor(s) 66 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 626. Volatile media include, without limitation, dynamic memory, such as the working memory 636.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 66 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600.

The communications subsystem 630 and/or components thereof generally will receive signals, and the bus 606 then might carry the signals and/or the data, instructions, etc. carried by the signals to the working memory 636, from which the processor(s) 66 retrieves and executes the instructions. The instructions received by the working memory 636 may optionally be stored on a non-transitory storage device 626 either before or after execution by the processor(s) 66.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known to those skilled in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

What is claimed is:

1. A system configured to facilitate a distributed manufacturing process, comprising:
a strong house system, a customer system, a supplier system, a product/quality control management system, wherein
the strong house system is configured to
communicate with the customer system, wherein the communication includes receiving a set of requirements for a product from the customer system, and transmitting one or more designs to the customer system indicating one or more proposed the designs for the product;
analyze the requirements received from the customer system and obtain a list of sub-requirements for the product; and
generate an order based on the sub-requirements;
the supplier system is operatively connected to the strong house system and configured to:
receive the order from the strong house system;
generate one or more bids based on the received order and transmit the one or more bids to the strong house system; and
generate one or more reports and transmit the reports to the product/quality control management system; and
the product/quality control management system is configured with one or more quality assurance standards and is configured to ensure the reports received from the supplier meet the one or more quality assurance standards.
